(19) United States
(12) Patent Application Publication
(10) Pub. No.: US 2008/0262709 A1
(43) Pub. Date: Oct. 23, 2008

(54) Pre-Tactical Control Facility

(76) Inventors: Andreas Pick, Braunschweig (DE); Florian Pickert, Braunschweig (DE); Oliver Franz Albert, Geinhausen (DE); Rainer Kaufhold, Darmstadt (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/577,481

(22) PCT Filed: Sep. 13, 2005
(86) PCT No.: PCT/DE05/01597

§ 371 Date: Mar. 4, 2008

(30) Foreign Application Priority Data
Oct. 20, 2004 (DE) 10 2004 050 988.3

(51) Int. Cl. G08G 5/00; G08G 9/00

(52) U.S. Cl. 701/117; 701/120

(57) ABSTRACT

Disclosed is a pre-tactical control device (1) for controlling traffic, which is to be connected to a tactical control system (2) used for assigning times of traffic events that are to be respected by means of transport at defined traffic junctions. Said pre-tactical control device (1) establishes target times (t_{z}) for traffic events of individual means of transport at the defined traffic junctions within a pre-tactical control time horizon which is greater than a tactical control time horizon of the tactical control system (2), the pre-tactical control device (1) comprising at least one assigned time of a traffic event. The target times (t_{z}) are determined at least in accordance with predefined traffic plans (FP), updates to said traffic plans (FP′), and predictions about the traffic capacities (KAP(t)) that can be handled at a traffic junction over time such that the target times (t_{z}) optimize the traffic events at the traffic junction regarding the capacity while respecting the traffic capacities (KAP(t)) that can be handled at a traffic junction, respecting the predefined traffic plans (FP), and keeping planning and controlling processes stable. The target times (t_{z}) are introduced into the tactical control system (2) as control parameters.

The invention relates to a pre-tactical control facility for traffic control, which is intended for connection to a tactical control system for assignment of traffic event times which must be complied with by vehicles at defined traffic nodes.

In complex traffic systems, for example air traffic control systems and railway networks, automatic control of the individual vehicles is essential in order to allow and to ensure smooth handling of traffic events at traffic nodes, in such a way that the traffic plans, that is to say the flight plans and driving plans, are complied with as accurately as possible for the vehicles. This control task for technical objects such as these can nowadays no longer be handled manually by traffic planners or air traffic controllers, but requires specialized automatic control systems.

Tactical control systems are sufficiently well known for air traffic control, assigning to an aircraft takeoff and landing times for aircraft in the tactical control time period up to about half an hour before the planned takeoff and the planned landing. The pilot must then ensure that he complies with the assigned traffic event times, which may be short time windows of a few minutes. The tactical control systems take account of local information and information in real time for the assignment of the traffic event times, but are often only able to react to a situation that has occurred. Owing to their relatively short time control period, tactical control systems do not have the capability to identify a developing poor traffic situation, and to react to it in good time.

Furthermore, strategic planning systems are known by means of which time windows, so-called slots, are allocated to the vehicle in the strategic prior-planning time period, which covers the traffic events and are considerably greater than the pre-tactical control time period, once and several hours before the actual traffic event. These time windows are relatively unaffected by newly occurring traffic situations. They can admittedly be canceled, renegotiated and also interchanged with one another after negotiations. However, the time windows are planned only on the basis of relatively short-term local information, such as the airport capacity. Since the strategic planning systems take account of the traffic flows in a very large area, and taking account of a large number of aircraft, planning is restricted to following up a relatively small number of higher-level aims for optimization.

The object of the invention is therefore to provide a pre-tactical control facility or traffic controller, by means of which it is possible to react to developing problematic traffic situations which can be foreseen in the medium term, and to counteract them, the traffic problem that would result from this by specific, timely control.

According to the invention, the object is achieved by the pre-tactical control facility of this generic type, in that the pre-tactical control facility is designed to define target times for traffic events of individual vehicles at the defined traffic nodes in a pre-tactical control time period which is greater than the tactical control time period of the tactical control system and includes the at least one assigned traffic event time, with the target times being determined at least as a function of predetermined traffic plans, of updates to the traffic plans and of prediction about the traffic capacities which can be handled over time at a traffic node, such that the target times optimize the traffic events at the traffic node in terms of the capacity while maintaining the traffic capacities which can be handled at a traffic node, maintaining the predetermined traffic plans and the stability of the planning and control, and with the target times being passed as control parameters to the tactical control system.

The calculation and distribution of target times to be achieved to the vehicles in a pre-tactical (medium-term) control period allows improved control of the traffic events at defined traffic nodes, such as airport runways, when the target times are determined as the result of an optimization of the capacity, of plan compliance and of plan stability, and are passed to a short-term tactical control system.

It is particularly advantageous it a further interface is provided to a strategic planning system for definition of time windows for traffic events of vehicles at a traffic node in a relatively long-term strategic prior-planning time period. In this case, the pre-tactical control time period is shorter than the longer-term strategic traffic planning time period, which likewise covers at least one assigned traffic event time. The target times defined by the pre-tactical control facility are then also passed to the strategic planning system, as a planning input variable.

Strategic planning systems such as these are, as has been stated in the introduction, known in air traffic control systems, in order to assign slots.

The pre-tactical control facility therefore closes a gap between the strategic control system and the tactical control system. In air traffic control systems, the pre-tactical control time period starts approximately two to three hours and ends about half an hour before the traffic event. In contrast, the strategic planning system covers a longer term traffic planning time period of two to three hours or more before the traffic event. The tactical control time period for the tactical control system in contrast occurs about half an hour before the traffic event. The use of the pre-tactical control facility for control purposes takes place, for example, in a control time window between the start of the tactical control time period and the start of the strategic control time period, but can also overlap the planning time window of the strategic planning system and the tactical control system.

It is particularly advantageous to provide an interface to the tactical control system for feeding back an estimated traffic event time for a traffic event, in order to feed back the traffic event time, which is determined as a function of the target times, to the pre-tactical control facility as a basic variable for optimization of the subsequent target times of further traffic events. This traffic event time, which may be a time range, is allocated for each vehicle, for example an airborne object, and can be checked for feasibility, in order to amend the flight plan as appropriate at short notice.

If the pre-tactical control facility is used to control air traffic, in particular takeoffs and landings as traffic events of aircraft as vehicles from a runway as a traffic node at an airport, it is advantageous if the target times are optimized by arranging the traffic events of the aircraft in sequence for utilization of the capacity taking into account stagger intervals, separate capacity predictions for takeoffs and landings and demand for traffic events. The traffic events of the aircraft are thus prepared as sequences, which are continuously improved by a suitable optimization algorithm.

It is also advantageous if the pre-tactical control facility is also used to define target times as a function of current or predicted weather conditions. Weather data is therefore also used as a criterion for optimization.

In this case, the traffic capacities that can be handled can be determined in particular as a function of the weather.

Furthermore, it is advantageous if the traffic node is used to calculate the target times at a runway threshold. Compliance of the predetermined traffic plans with the plan should in contrast be assessed relative to the preparation stand for the respective aircraft, for optimization of the target times. The conversion of plan compliance to the threshold is then carried out by means of taxi times and/or deicing times for the aircraft, which can be predetermined as standard, or are currently measured comparative times.

The invention will be explained on the basis of air traffic control, by way of example, in the following text, and with reference to the attached drawings, in which:

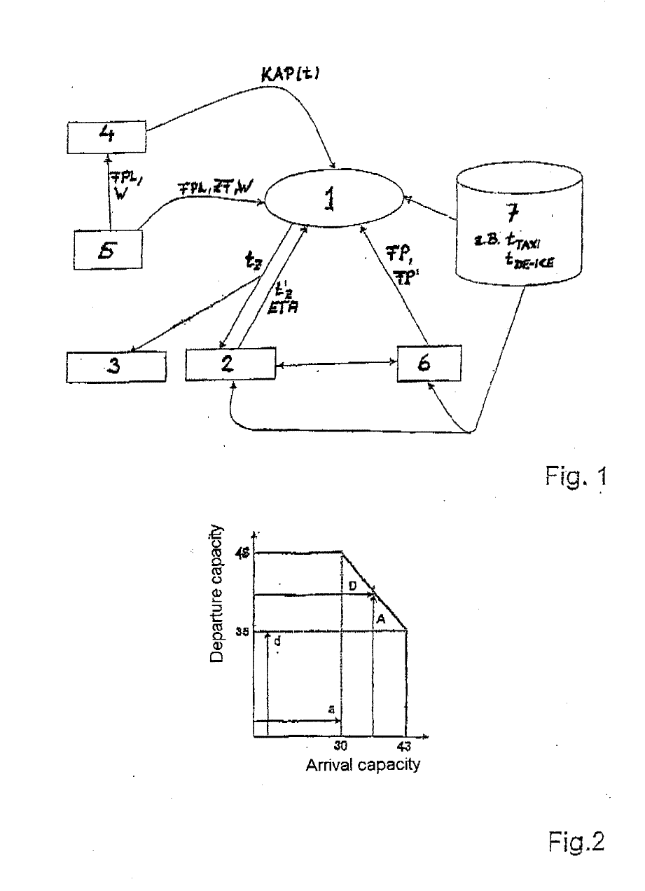

FIG. 1 shows a block diagram of a pre-tactical control facility in conjunction with a tactical control system, and a strategic planning system;

FIG. 2 shows a diagram of the departure capacity plotted against the arrival capacity, for adaptation of an operating point for optimization;

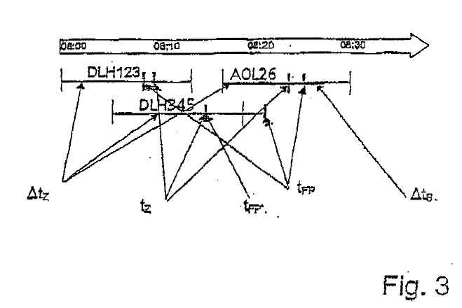

FIG. 3 shows an illustration of the slots, target times and tactical traffic event times.

FIG. 1 shows a block diagram of the pre-tactical control facility 1, which is connected to a tactical control system 2 for control within a tactical (short-term) control period of about 30 minutes before the traffic events, and to a strategic planning system 3. The strategic planning system 3 covers a strategic (long-term) planning time period of more than two to three hours before the traffic event, in particular the takeoff or landing of an aircraft.

The pre-tactical control facility receives capacity predictions KAP(t) for the runways as well as the take-off and landing demand (DEMAND) for vehicles over the time t. The capacity predictions KAP(t) are created using known capacity prediction tools 4, which are available at airports, from a currently selected capacity FPL, the so-called flow-value of tactical control systems, as well as a statistical analysis of historical data as a function of weather data W. The flow value FPL, the current situation at the airport ZF and the weather data W, in particular, are also made available by an airport status determination tool 5 to the capacity prediction tool 4 and to the pre-tactical control facility 1.

Furthermore, a flight plan generator 6 is provided in order to make a current flight plan FP as well as updated flight plans FP′ available to the pre-tactical control facility 1 on the basis of a database 7. The flight plan generator 6 is likewise connected to the tactical control system 2, in order to adapt the flight plans FP on the basis of short-notice control action in the air traffic system.

The pre-tactical control facility 1 is designed to define target times for traffic events, in particular takeoffs and landings, or individual airborne objects passing over radio beacons, at the defined traffic nodes (runway, radio beacon, etc.) within a pre-tactical medium-term control time period, which covers the traffic event, in the range between two to three hours and about 30 minutes before the traffic event. The target times t_{z} are passed to the tactical control system 2 and, optionally, to the strategic planning system 3 as well, for further planning and in particular for control purposes.

In this case, the target times t_{z} are determined at least as a function of the predetermined flight plans FP, the updates of the flight plans FP′ and the capacity predictions KAP(t) of the traffic capacities which can be handled at the traffic node over the time t, such that the target times t, optimize the traffic events at the traffic node in terms of the capacity while maintaining the traffic capacities KAP(t) which can be handled at a traffic node, maintaining the predetermined flight plans FP and the stability of the planning and control.

On the basis of target times t_{z} previously determined by the pre-tactical control facility 1, the tactical control system 2 supplies estimated tactical traffic event times t′_{z} for a traffic event, such as an estimated time of arrival ETA or an estimated time of departure, and this is used there as a basic variable for the optimization of the subsequent target times t_{z} of further traffic events.

The pre-tactical control facility 1 can also be used in order to simulate different situations by variation of constraints, in particular by shifting traffic events, in this way optimizing the handling of the air traffic.

The pre-tactical control facility 1 allows the departure times at a previous airport for an airborne object to be aligned as far as possible so as to allow arrivals of undisturbed flights to be handled without any delay. The departure times at the previous airport are thus dynamically updated, and are matched to the respective new situation. The control of the air traffic should thus use the pre-tactical control facility 1 to access a departure airport in order to optimize the handling at an airborne object's arrival airport.

In principle, the pre-tactical control facility 1 operates completely automatically, with the data provided by interfaces being organized and managed in the database 7.

Estimated traffic event times ETA and ETD (estimated time of arrival and estimated time of departure) are in most cases determined for each flight, independently of the overall situation. The traffic event times ETA, ETD are appropriately corrected using the knowledge of the overall situation, in particular the capacity KAP(t) and the demand for traffic events (Demand). This is particularly true in a situation in which the available capacity KAP(t) is less than the predicted demand for traffic events. The adaptation process is in this case carried out on the basis of the current frequency of traffic events, as defined by the tactical control system 2.

For each flight, the pre-tactical control facility 1 determines a target time t_{z} taking into account optimization functions based on information about:
predicted capacity
planned flight time (schedule-published flight plan with operationally necessary adaptations, slot)
estimated flight time (estimate)
   and the target times t_{z} are dynamically matched to the changing constraints. The respective target time t_{z} is used by the pre-tactical control facility 1 to additionally determine the possible target times Δt_{z}, for example TTL/TTG (Time to Lose, Time to Gain). Control action is also taken for quantity control for individual aircraft, so that quantity control is the aim to be achieved but as a means such as all flights must work towards target times t_{z}.

The optimization is carried out on the basis of the following optimization criteria:

a) flow:
taking account of the optimum arrival/departure points
   b) plan compliance
absolute punctuality (with respect to the published flight plan)
operational or relative punctuality (with respect to the flight plan taking account of constraints)
slot compliance
plan stability:
minimum change to the control actions between a plurality of planning results
minimum change to the target times t_{z}.

For optimization on the basis of the flow, it is desirable to achieve the maximum number of aircraft handled subject to the given constraints.

For optimization based on plan compliance, requirements must be taken into account relating to the importance of arrival/departure plan compliance.

In the case of absolute plan compliance, the aim is to comply with the schedule time (position-related) as published in the flight plan, with a time window of, for example, plus or minus 15 minutes. Optimum plan compliance is accordingly achieved if all departures and arrivals take place off-block and on-block within the time window. Absolute plan compliance for target intervals to be defined can be determined and taken into account both as a prediction with the difference between the estimate and schedule and/or the difference between the target time and the schedule, and, as the achieved characteristic value, from the difference between the current time and the schedule.

Furthermore, the relative plan compliance can be taken into account for optimization, which is determined from the flights which operate in accordance with the schedule and flights allocated to slots. The basis for determination of relative plan compliance for updating of slots is always the updated value. Relative plan compliance can be determined and taken into account for time intervals to be defined both as a prediction as the difference between the estimate and the schedule/slot and/or as the difference between the target time and the schedule/slot, as well as the achieved characteristic value as the difference between the current value and the schedule/slot.

Furthermore, operational plan compliance can be used for optimization, assessing the compliance with the target times t_{z} (position-related) with respect to defined times, as planned by the pre-tactical control facility 1. The pre-tactical control facility 1 determines block-related or flight path-related target times t_{z} for all flights in an optimized manner. The target times t_{z} may differ from the flight plan, and are updated dynamically on the basis of changing constraints.

Operational plan compliance provides a measure for the quality of the target times t_{z} determined. It is therefore determined exclusively as a characteristic value or subsequent analysis, rather than as a prediction. Operational plan compliance is determined from the difference between the actual value ATA/ATD (actual time of arrival, actual time of departure) and the target time t, (for selected times t) and/or as the difference between the actual value ATA/ATD and the traffic event time (estimate) with respect to selected times t. The actual value ATA/ATD is the actually achieved arrival or departure time.

The aim of optimization based on plan stability is to make as few control actions as possible for an individual vehicle.

Furthermore, all of the existing or predicted constraints relating to the respective planning time are taken into account in the optimization process. For example, these include the available capacity, flight plan configuration (arrival/departure/overall capacity), operating procedures (weather-determined), runway blockages (including temporary: inspection, friction test, . . . ), time intervals between successive operations (separation for takeoffs and landings), sector capacity for arrivals (AC/metering fix), noise contingency). Other constraints include target time windows Δt_{z}, planned time windows to be complied with Δtₛ (slots), confirmed off-block time COB (estimated earliest possible block-related departure time), estimated traffic event times, in particular estimated time of arrival ETA and estimated time of departure ETD. Other constraints include external criteria, such as the position availability, the maximum available area for aircraft, and the maximum available aircraft taxi routes. Other process times can likewise be taken into account if necessary, provided that they are available in an automated system.

The optimization process is carried out by determination of an optimum point for all time intervals, that is to say by optimum distribution between landings and takeoffs (arrivals and departures), with respect to the maximum traffic flow and maximum plan compliance. In this case, account is taken of the demand for traffic events (Demand), the capacity KAP(t) and the point at which variables that vary over time occur.

FIG. 2 shows a diagram for automatic adaptation of the point at which events occur for a planning time. The diagram shows the departure capacity plotted against the arrival capacity. An actual point is determined by taking account of the arrival/departure capacity distribution and the demand. In this process, it is advantageous to allocate the highest priority to arrivals in an arrival peak and to departures in a departure peak. During the transition from an arrival peak to the departure peak, it is worthwhile not suddenly switching the prioritization of the arrivals to the prioritization of the departures, but adapting this transition to the requirement and to plan compliance, and building up the prioritization of the departures slowly. The available optimum landing and take-off capacity is then defined on the basis of this point, and is optimized in terms of plan compliance and demand for traffic events. The traffic events can then be spread out over these specific capacities by assignment of target times t_{z}.

FIG. 3 shows a diagram in order to show the target times as defined by the pre-tactical control facility for an aircraft, as well as the tactical traffic event times ETA, target time window Δt_{z} and slots Δtₛ.

The traffic event time t_{FP} is defined for each aircraft DLH123, AOL26, DLH345, together with the associated traffic event, for example the takeoff of the aircraft DLH123. In a strategic planning system 3, a slot Δtₛ is allocated up to about two to three hours before departure, within which the planned traffic event time t_{FP} occurs. The planned traffic event time t_{FP} (schedule, flight plan time) may be shifted later as a result of external events, such as delays to other aircraft, a capacity shift in the handling on the runway and the terminal, as well as delays to passengers, together with technical problems.

A target time t_{z} for departure is allocated to the aircraft in the medium term in a control time period of two hours up to about 30 minutes before departure, taking account of the airport constraints that are known in the medium-term control time period, and are optimized with respect to the available traffic capacities on the runway, plan compliance of the flight plan FP and plan stability. During this process, target time windows Δt_{z} are defined, within which the departure times and target times t_{z} can be shifted. The target time windows Δt_{z} are used in order to make it possible to select which aircraft must be taken into account in a planning interval, and in order then to optimize them for these aircraft within the planning interval.

The control system is then used to overcome capacity bottlenecks and to optimally match the available capacity to the demand for traffic events.

1. A pre-tactical control facility (1) for traffic control, which is intended for connection to a tactical control system (2) for assignment of traffic event times which must be complied with by vehicles at defined traffic nodes, characterized in that the pre-tactical control facility is designed to define target times (t_{z}) for traffic events of individual vehicles at the defined traffic nodes in a pre-tactical control time period which is greater than a tactical control time period of the tactical control system (2) and includes the at least one assigned traffic event time, with the target times (t_{T}) being determined at least as a function of predetermined traffic plans (FP), of updates to the traffic plans (FP′) and of prediction about the traffic capacities (KAP(t)) which can be handled over time at a traffic node, such that the target times (t_{z}) optimize the traffic events at the traffic node in terms of the capacity while maintaining the traffic capacities (KAP(t)) which can be handled at a traffic node, maintaining the predetermined traffic plans (FP) and the stability of the planning and control, and with the target times (t_{z}) being passed as control parameters to the tactical control system (2)

2. The pre-tactical control facility (1) as claimed in claim 1, characterized by an interface to a strategic planning system (3) for definition of time windows (Δtₛ) for traffic events of vehicles at a traffic node in a strategic prior-planning time period, which is greater than the pre-tactical control time period and includes at least one assigned traffic event time, and the target times (t_{z}) defined by the pre-tactical control facility (1) are passed to the strategic planning system (3), as a planning input variable.

3. The pre-tactical control facility (1) as claimed in claim 1, characterized in that by an interface to the tactical control system (2) for feeding back an estimated tactical traffic event time (ETA/ETD-Estimated Time of Arrival/Departure) for a traffic event, which has been determined as a function of the target times (t_{z}), to the pre-tactical control facility (1) as a basic variable for optimization of the subsequent target times (t_{z}) of further traffic events.

4. The pre-tactical control facility (1) as claimed in claim 1 for control of air traffic, in particular of the takeoffs and landings as traffic events of aircraft as vehicles on a runway as a traffic node at an airport, characterized in that the target times (t_{z}) are optimized by arranging the traffic events of the aircraft in sequence for utilization of the capacity taking into account stagger intervals, capacity predictions (KAP(t)) and demand for traffic events (DEMAND).
